(19) United States
(12) Patent Application Publication
(10) Pub. No.: US 2026/0017857 A1
(43) Pub. Date: Jan. 15, 2026

(54) System and Method For Dynamic Web Content Generation

(71) Applicant: NuRD LLC, Bloomfield, NJ (US)

(72) Inventor: Mehmet Ozer Metin, Livingston, NJ (US)

(21) Appl. No.: 19/258,114

(22) Filed: Jul. 2, 2025

Related U.S. Application Data
(60) Provisional application No. 63/669,611, filed on Jul. 10, 2024.

(51) Int. Cl. G06T 11/60; G06F 3/0484

(52) U.S. Cl. CPC G06T 11/60; G06F 3/0484; G06T 2200/24

(57) ABSTRACT

There is provided a system and methods for dynamic web personalization using artificial intelligence (AI) and generative UI components. The architecture integrates various modules and interfaces to enhance user interaction and content relevance on web platforms. The components include: input interface; AI mode; content management and generation; feedback loop; content management system and integration; and query and response flow.

### CROSS REFERENCE TO RELATED APPLICATIONS

This application claims benefit of and priority to U.S. Provisional Patent Application Ser. No. 63/669,611, filed on Jul. 10, 2024 and incorporated by reference herein in its entirety.

### FIELD OF THE INVENTION

The invention relates to the field of web content generation and presentation, and more particularly to using generative user interface to create content and components.

### BACKGROUND OF THE INVENTION

The field of web personalization has seen significant advancements due to the integration of artificial intelligence (AI) and large language models (LLMs). Traditionally, web personalization has relied on static content adjustment based on user demographics or past interactions. However, with the increasing complexity of user needs and the dynamic nature of web interactions, there is a pressing need for a more adaptable and responsive approach to personalization.

Recent developments in AI, especially in LLMs, have enabled more sophisticated data processing capabilities, allowing systems to understand and predict user behavior in unprecedented ways. Despite these advancements, most current systems still lack the ability to dynamically generate and adjust user interface (UI) components that are tailored not just to content preferences but also to usability and aesthetic user preferences.

Moreover, conventional methods for web personalization do not incorporate continuous feedback loops that adjust content and UI in real-time. They often rely on pre-defined A/B testing schedules, which can delay the optimization process and fail to capture the immediate reactions of users to changes in UI and content. This lack of responsiveness can result in suboptimal user experiences and reduced engagement.

Furthermore, the challenge of integrating real-time data analytics with content generation and UI design in a seamless manner remains largely unaddressed. Existing systems typically handle these components separately, leading to inefficiencies and a disjointed user experience.

### SUMMARY OF THE INVENTION

The proposed system addresses these gaps by introducing an AI-driven, real-time adaptive framework for web personalization. This framework utilizes state-of-the-art technologies in machine learning and AI to not only generate content based on historical and contextual data but also to create and modify UI components that resonate with current user interactions. The continuous A/B testing and feedback mechanisms ensure that the system remains agile and effective, responding promptly to user preferences and behaviors to enhance engagement and satisfaction.

The present invention describes an advanced system and methodology for dynamic web content generation and presentation using Generative UI, which leverages large language models (LLMs) and artificial intelligence (AI) to create highly relevant content and UI components based on provided or crawled information from the websites. The system is designed to not only retrieve and generate relevant content from a comprehensive content database according to user queries but also to generate and adapt user interface components using AI. It extends beyond textual content to include user interface elements, tailored to individual user preferences and behaviors. These components are crafted in real-time to match the user's preferences, queries and interaction patterns, enhancing the overall user experience as well as provide new mode of interaction with the website or web application.

This invention sets a new standard for web content presentation and also interaction with the websites, combining state-of-the-art AI capabilities with sophisticated data analytics to deliver a uniquely tailored user experience that evolves with user interactions, making web content not only more accessible but also more engaging. Central to this system is its ability to perform A/B testing on-the-fly, allowing for continual adjustments in content and UI elements based on real-time user feedback, including views and clicks. This feedback loop is integral to the system, facilitating continuous learning and adaptation to optimize user engagement and satisfaction. By employing AI-driven algorithms, the system dynamically adjusts and generate web components based on user queries, thereby significantly increasing user interaction.

### BRIEF DESCRIPTION OF DRAWINGS

FIG. 1 is an illustration of the system of the present invention;

FIG. 2 is an illustration of an online shopping website;

FIG. 3 is an illustration of a website with the present invention.

FIG. 4 is an illustration of the processors, memory, and storage devices within a computing device.

FIG. 5 is a schematic of an individual user operating a computer or handheld device which is connected to the internet.

### DETAILED DESCRIPTION OF THE INVENTION

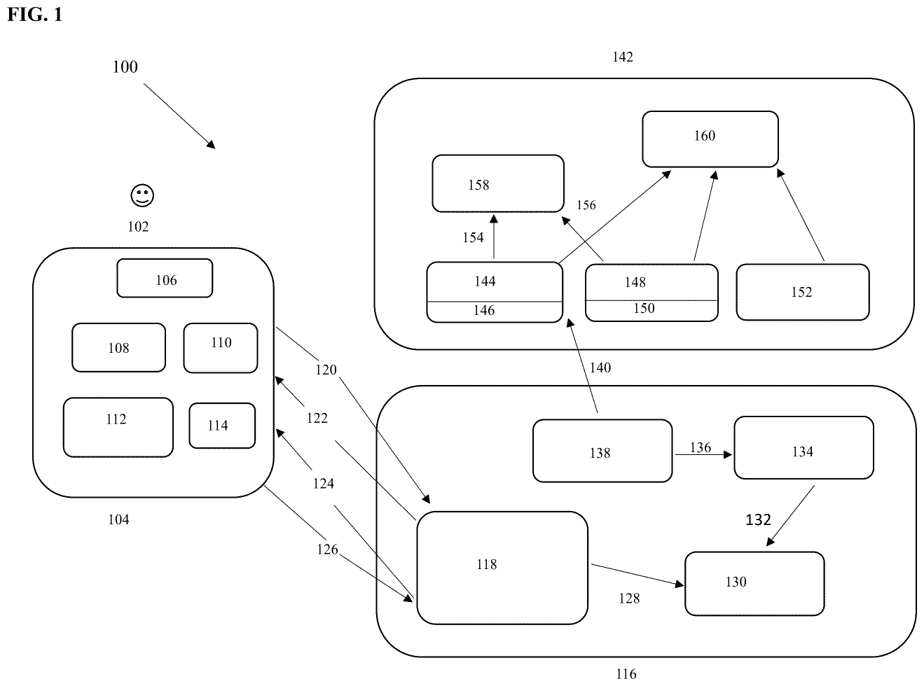

Referring to FIG. 1, there is shown a summary of the system architecture and interactions 100. FIG. 1 illustrates a comprehensive system architecture 100 designed for dynamic web personalization using artificial intelligence (AI) and generative UI components. This architecture integrates various modules and interfaces to enhance user 102 interaction and content relevance on web platforms. Below is a detailed description of each component and their interactions within the system.

The user devices 104 have various input interfaces. These include: a microphone 106, which allows voice commands and queries to be input into the system; and a browser 108 and browser plugin 110. The browser 108 and browser plugin 110 facilitates web-based user inputs through standard or enhanced web browsing capabilities. A desktop application 112 and SDK 114 are included which support additional applications and software development kits that integrate with the system for extended functionalities.

The AI Model 118 is central to the system 116 and the AI model 118 processes user queries 120 to generate content 122 and User interface components 124 dynamically. It fetches relevant content data 128 from the content data store 130, which is continuously updated by crawlers 138 and indexers 134.

The system of the present invention includes content management and generation: The content data base 158 stores both static 154 and dynamic content 156 which can be utilized by the AI model 118 for content generation. The system 116 includes a crawler 138 and indexer 134, which are crucial for maintaining an up-to-date content data store 130 by crawling web resources 140 and indexing new content. The system 116 generates content 122 and UI elements 124 by the AI model 118 uses the data from the content data store 130 and content data base 158 to generate content 122 and UI elements 124 tailored to the user's 102 current context and past interactions.

A feedback loop/mechanism 126 is incorporated by the system 116 which captures user interactions (views and clicks) with the generated content 122 and UI elements 126. This data is fed back to the AI model 118 to refine and optimize future content and UI generation.

A Content Management System (CMS) and integration in included. The CMS 160 manages dynamic content 156 updates and integrates with various web platforms. The crawler 138 interacts with website 144, web application(s) 148, SDK 150 and plugin(s) 152. These tools allow for the integration of the personalized content and UI into different web environments and platforms, ensuring that the personalized experience can be deployed across a diverse range of web applications.

The query 120 and response flow is part of the present invention and is as follows. The process starts when a user input is received through any of the input interfaces. The query 120 is processed by the AI model 118, which then interacts with the content data store 130 and content database 158 to generate the appropriate content 122 and UI elements 124. The output is then displayed to the user 102, while the feedback 126 from the user interaction is looped back to the system 116 to enhance and personalize future interactions.

This architecture emphasizes a seamless integration of AI-driven content generation and real-time user interface customization, facilitated by a robust backend that continually updates and refines the content repository. Through this setup, the system ensures that each user interaction is maximally engaging and personalized, leading to increased user satisfaction and web interaction.

FIG. 1 illustrates the user 102 and the user devices 104 (microphone 106, browser 108, browser plugin 110, desktop application 112, and SDK 114). As shown, the user 102 queries 120 the system 116 of the present invention 100. Within the system 116 of the present invention 100, there is the AI model 118 to fetch relevant content 128 at the content data store 130. A web crawler 138, having crawled websites 140 for content, indexes 136 the website content 154, 156 with an indexer 134. The indexer 134 sends content to store 132 at the content data store 130.

The web crawler 138 is shown interacting with web sites or web applications 142 and crawling 140 the web sites 144 and web application 148 for content. As shown, there is a website 144 with a code snippet 146 and the static content 154 of the web site 144 is communicated to and from the content database 158. Similarly, for the web site 144 with code snippet(s) 146, the dynamic content 156 is communicated to and from the content management system (CMS) 160. Also shown is the web application 148 with an SDK 150 and website plug in(s) 152, each of these communicating dynamic content 156 with the CMS 160. The web application 148 (with SDK 150) are also communicating static content 154 with the content data base 158.

The system 116, having received the information and content from the crawled websites 140, generates content 122 and generates user interface elements 124 through the AI model 118. These are then sent back to the user devices 104. Feedback 126 is sent back to the AI model 118 from user devices 104 for a continuous loop of information 124 and content 122.

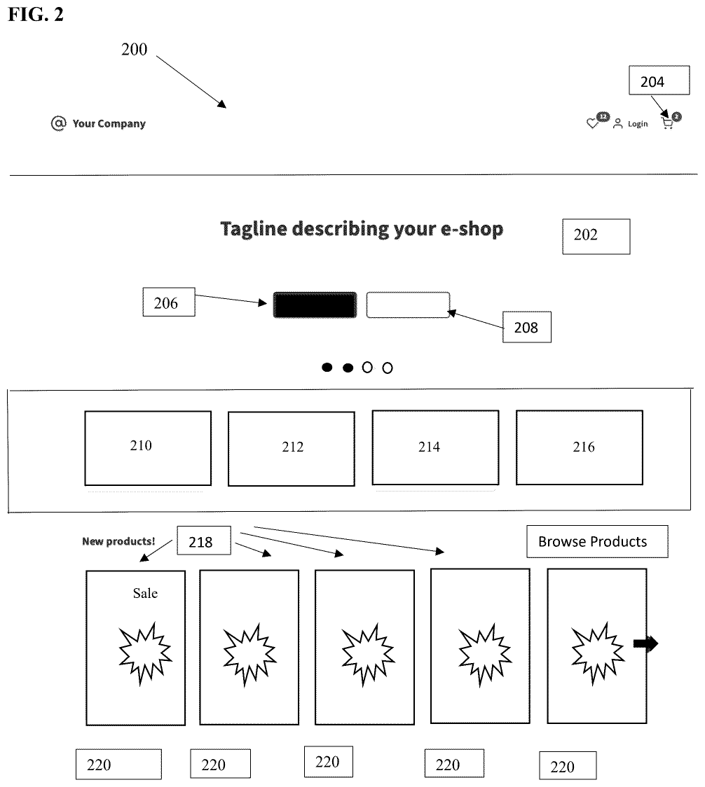

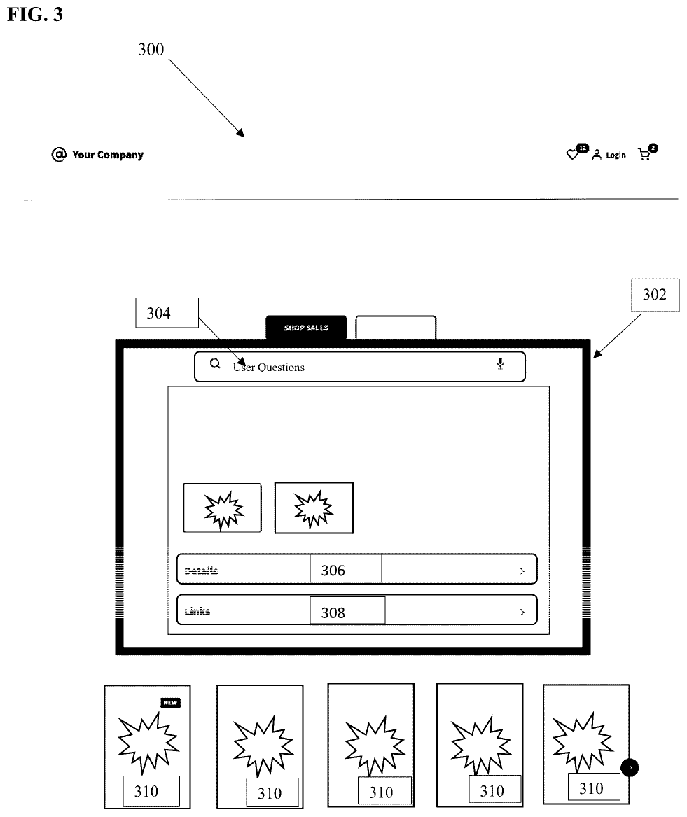

FIG. 2 illustrates an online shopping website 200 and FIG. 3 is an illustration of a website 300 with the present invention. The website 200 in FIG. 2 indicates a purchasing page 202 with a shopping cart 204 and identifies sales 206 and products 208, with bestsellers 210, seasonal 212, categories 214, and outlets 216. The new products 218 are also included on the webpage 202 with pricing 220. FIG. 3 indicates the webpage 300 with the present invention system and method, indicating how the user interface 302 has changed, with a search function bar 304, details 306 and links 308 tabs for a personalized interaction and category highlights 310 presented to the user.

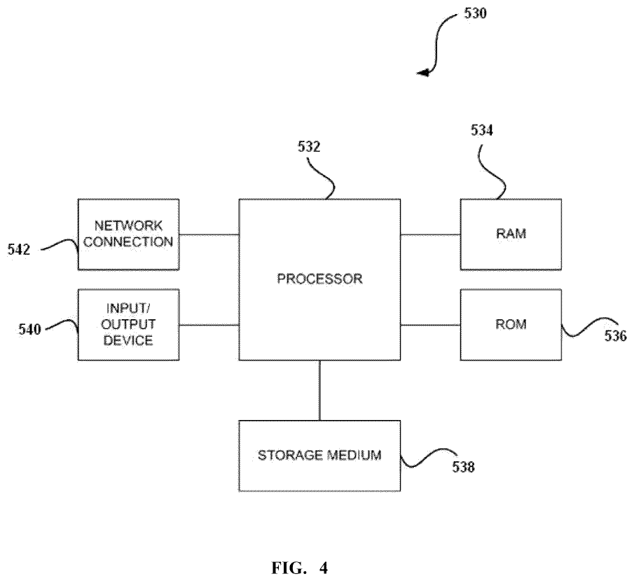

The system and method according to the present invention may be implemented on a computer system or devices, such as tablets or smart phone devices. The present invention may be implemented within a system with which may include substantially any suitable computing device. By way of example, the present invention may generally be implemented within an overall computing network which includes a plurality of computing devices. FIG. 4 illustrates a computing device or individual computer system suitable for implementing the present invention. A computing device or individual computer system 530 includes any number of processors 532 (also referred to as central processing units, or CPUs) that are coupled to memory devices including primary storage devices 534 (typically a random access memory, or RAM) and primary storage devices 536 (typically a read only memory, or ROM). ROM acts to transfer data and instructions uni-directionally to the CPU 532, while RAM is used typically to transfer data and instructions in a bi-directional manner.

CPU 532 may generally include any number of processors. Both primary storage devices 534, 536 may include any suitable computer-readable media. A secondary storage medium 538, which is typically a mass memory device, is also coupled bi-directionally to CPU 532 and provides additional data storage capacity. The mass memory device 538 is a computer-readable medium that may be used to store programs including computer code, data, and the like. Typically, mass memory device 538 is a storage medium such as a hard disk or a tape which is generally slower than primary storage devices 534, 536. Mass memory storage device 538 may take the form of a magnetic or paper tape reader or some other well-known device. It will be appreciated that the information retained within the mass memory device 538, may, in appropriate cases, be incorporated in standard fashion as part of RAM 534 as virtual memory. A specific primary storage device 536 such as a CD-ROM may also pass data uni-directionally to the CPU 532.

CPU 532 is also coupled to one or more input/output devices 540 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 532 optionally may be coupled to a computer or telecommunications network, e.g., a local area network, an internet network or an intranet network, using a network connection as shown generally at 542. With such a network connection, it is contemplated that the CPU 532 might receive information from the network, or might output information to the network in the course of performing the above-described method steps. Such information, which is often represented as a sequence of instructions to be executed using CPU 532, may be received from and outputted to the network, for example, in the form of a computer data signal embodied in a carrier wave. The above-described devices and materials will be familiar to those of skill in the computer hardware and software arts.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “computer readable storage medium” may be any tangible medium (but not a signal medium—which is defined below) that can contain, or store a program. The terms “machine readable medium,” “computer-readable medium,” or “computer readable storage medium” are all non-transitory in their nature and definition. Non-transitory computer readable media comprise all computer-readable media except for a transitory, propagating signal.

The term “machine-readable signal” refers to any signal used to provide machine instructions and/or data to a programmable processor. A “computer readable signal medium” may be any computer readable medium that is not a computer readable storage medium and that can communicate, propagate, or transport a program.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

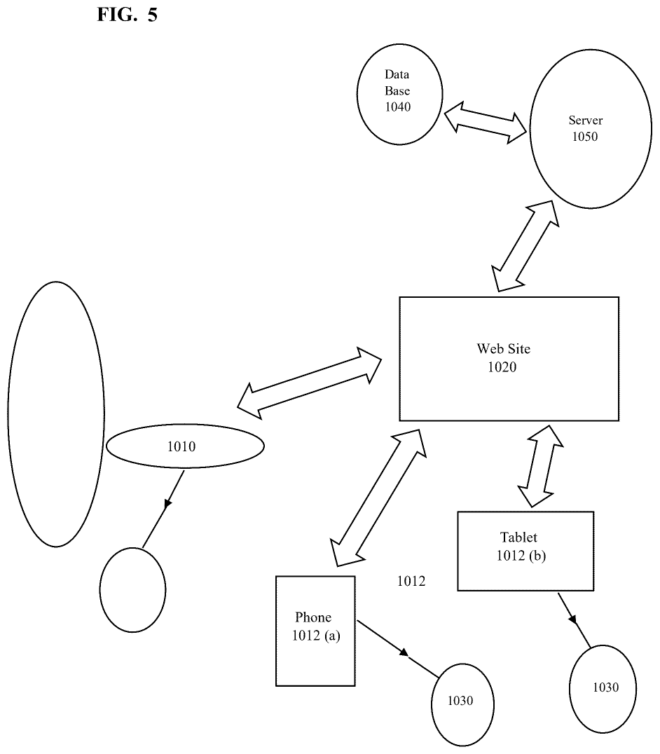

As shown generally by FIG. 5, there is a user 1000 of a computer 1010 or handheld device 1012 who accesses an Internet website 1020 with network connections to a server 1050 and database 1040. The computer 1010 or handheld device is compatible with operating systems known in the art, such as Windows, iOS or android devices or android type operating systems. The user 1000 is potentially exposed to many malicious or unsafe applications located on the web or a particular website 1020 due to lack of security and validation with the source, even though the website 1020 itself may be known as reliable and trusted. The website may be an application store or directory which includes other software applications for downloading. Similarly, receiving email may introduce unsafe internet links, applications and attachments to the user's computer or device. Those of skill in the art would recognize that the computer 1010 or handheld devices 1012a or 1012b each has a processor and a memory coupled with the processor where the memory is configured to provide the processor with executable instructions. A boot disk 1030 is present for initiating an operating system as well for each of the computer 1010 or handheld devices 1012. It should also be noted that as used herein, the term handheld device includes phones, smart phones, tablets, personal digital assistants, media and game players and the like. It should also be understood that the user's computer or device may be part of an internal network or system which is communicating with the Internet. As used throughout the specifications, the term “query” or “queries” is used in the broadest manner to include requests, polls, calls, summons, queries, and like terms known to those of skill in the art.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A system for dynamic web personalization comprising,
at least one input interface;
an artificial intelligence (AI) model;
a content management and generation module having a content data base, a crawler and indexer, and generated content and user interface elements;
a feedback loop;
content management system and integration; and
query and response flow;
said system receiving a user input through said at least one input interface, said user input processed by said artificial intelligence model;
a query of said user processed by the artificial intelligence model,
said artificial intelligence model interacts with the content data base to generate said generated content and said user interface elements;
displaying output to said user as said feedback loop sends feedback from the user input back to said system to personalize interactions.
